(19) United States
(12) Patent Application Publication
(10) Pub. No.: US 2026/0066976 A1
(43) Pub. Date: Mar. 5, 2026

(54) METHOD FOR DETERMINING PRECODING MATRIX OF ORBITAL ANGULAR MOMENTUM (OAM) AND APPARATUS THEREOF

(71) Applicant: Beijing Xiaomi Mobile Software Co., Ltd., Beijing (CN)

(72) Inventors: Gaoming DUAN, Beijing (CN); Liangang CHI, Beijing (CN)

(21) Appl. No.: 19/106,939

(22) PCT Filed: Sep. 1, 2022
(86) PCT No.: PCT/CN2022/116612

§ 371 Date: Feb. 26, 2025

(51) Int. Cl. H04B 7/06

(52) U.S. Cl. CPC H04B 7/0691; H04B 7/0617; H04B 7/0634

(57) ABSTRACT

A method for determining a precoding matrix of OAM and an apparatus thereof, which can be used in communication systems. The method comprises: on the basis of target antenna array units among antenna array units on a uniform circular array, independently sending respective reference signals to a second communication device (S201); receiving a precoding matrix indication index (PMI) of each target antenna array unit, which is determined on the basis of a reference signal and sent by the second communication device (S202); and according to the PMI of the target antenna array unit, determining a precoding matrix of each antenna array unit on the uniform circular array (S203). By means of the method for determining the precoding matrix of OAM and the apparatus thereof, beamforming can be separately performed on the antenna array units, thus suppressing the divergence angle of an OAM beam, and increasing the transmission distance of an OAM communication system.

### CROSS-REFERENCE TO RELATED APPLICATION

The present application is a U.S. National Stage of International Application No. PCT/CN2022/116612, filed on Sep. 1, 2022, the contents of all of which are incorporated herein by reference in their entireties for all purposes.

### BACKGROUND OF THE INVENTION

An orbital angular momentum (OAM) beam has a concave center and divergence pattern. In related art, the reception and detection of the OAM beam may be performed by receiving a whole circular beam using a large-aperture antenna array.

### SUMMARY OF THE INVENTION

Embodiments of the present disclosure provide a method for determining a precoding matrix for OAM and an apparatus thereof, which may be applied in the field of communications.

In a first aspect, a method for determining a precoding matrix for OAM is provided. The method for determining the precoding matrix for the OAM includes: independently sending respective reference signals to a second communication device based on target antenna array units among antenna array units on a uniform circular array (UCA); receiving a precoding matrix index (PMI) of each target antenna array unit determined based on the reference signals and sent by the second communication device; and determining a precoding matrix for each antenna array unit on the uniform circular array according to the PMIs of the target antenna array units.

In a second aspect, another method for determining a precoding matrix for OAM is provided. The method for determining the precoding matrix for the OAM includes: receiving reference signals sent independently by a first communication device through designated target antenna array units on a uniform circular array (UCA); and determining a precoding matrix index (PMI) of each target antenna array unit based on the reference signals, and sending the PMI to the first communication device, where the PMI is used to determine a precoding matrix for each antenna array unit on the uniform circular array.

In a third aspect, a communication apparatus is provided. The communication apparatus has some or all of functions for realizing a terminal in the method according to the first aspect, e.g., the communication apparatus may have functions in some or all of the embodiments in the present disclosure, or may have a function for implementing any one of the embodiments in the present disclosure alone. The functions may be implemented by hardware or by hardware executing corresponding software. The hardware or software includes one or more units or modules corresponding to the functions.

A structure of the communication apparatus may include a transceiving module and a processing module. The processing module is configured to support the communication apparatus in performing corresponding functions in the method. The transceiving module is configured to support communications between the communication apparatus and other devices. The communication apparatus may further include a storage module. The storage module is configured to be coupled to the transceiving module and the processing module, and stores necessary computer programs and data of the communication apparatus.

In a fourth aspect, another communication apparatus is provided. The communication apparatus has some or all of functions for realizing a network device in the method example according to the second aspect, e.g., the communication apparatus may have functions in some or all of the embodiments in the present disclosure, or may have a function for implementing any one of the embodiments in the present disclosure alone. The functions may be implemented by hardware or by hardware executing corresponding software. The hardware or software includes one or more units or modules corresponding to the functions.

A structure of the communication apparatus may include a transceiving module and a processing module. The processing module is configured to support the communication apparatus in performing corresponding functions in the method. The transceiving module is configured to support communications between the communication apparatus and other devices. The communication apparatus may further include a storage module. The storage module is configured to be coupled to the transceiving module and the processing module, and stores necessary computer programs and data of the communication apparatus.

In a fifth aspect, a communication apparatus is provided. The communication apparatus includes a processor. The processor, when calling a computer program in a memory, performs the method according to the first aspect.

In a sixth aspect, a communication apparatus is provided. The communication apparatus includes a processor. The processor, when calling a computer program in a memory, performs the method according to the second aspect.

In a seventh aspect, a communication apparatus is provided. The communication apparatus includes a processor and a memory. A computer program is stored in the memory. The processor executes the computer program stored in the memory so as to enable the communication apparatus to perform the method according to the first aspect.

In an eighth aspect, a communication apparatus is provided. The communication apparatus includes a processor and a memory. A computer program is stored in the memory. The processor executes the computer program stored in the memory so as to enable the communication apparatus to perform the method according to the second aspect.

In a ninth aspect, a communication apparatus is provided. The communication apparatus includes a processor and an interface circuit. The interface circuit is configured to receive code instructions and transmit the code instructions to the processor. The processor is configured to run the code instructions so as to enable the communication apparatus to perform the method according to the first aspect.

In a tenth aspect, a communication apparatus is provided. The communication apparatus includes a processor and an interface circuit. The interface circuit is configured to receive code instructions and transmit the code instructions to the processor. The processor is configured to run the code instructions so as to enable the communication apparatus to perform the method according to the second aspect.

In an eleventh aspect, a system for determining a precoding matrix for OAM is provided. The system includes the communication apparatus according to the third aspect and the communication apparatus according to the fourth aspect. Alternatively, the system includes the communication apparatus according to the fifth aspect and the communication apparatus according to the sixth aspect. Alternatively, the system includes the communication apparatus according to the seventh aspect and the communication apparatus according to the eighth aspect. Alternatively, the system includes the communication apparatus according to the ninth aspect and the communication apparatus according to the tenth aspect.

In a twelfth aspect, a non-transitory computer-readable storage medium is provided. The non-transitory computer-readable storage medium is configured to store instructions used by the above-mentioned terminal. When executed, the instructions enable the terminal to perform the method according to the first aspect.

In a thirteenth aspect, a non-transitory computer-readable storage medium is provided. The non-transitory computer-readable storage medium is configured to store instructions used by the above-mentioned network device. When executed, the instructions enable the network device to perform the method according to the second aspect.

In a fourteenth aspect, a computer program product including a computer program is further provided. When running on a computer, the computer program product enables the computer to perform the method according to the first aspect.

In a fifteenth aspect, a computer program product including a computer program is further provided. When running on a computer, the computer program product enables the computer to perform the method according to the second aspect.

In a sixteenth aspect, a chip system is provided. The chip system includes at least one processor and an interface and is configured to support a terminal in implementing functions involved in the first aspect, such as determining or processing at least one of data or information involved in the method. In a design, the chip system further includes a memory. The memory is configured to store necessary computer programs and data of the terminal. The chip system may consist of a chip, or may also include a chip and other discrete devices.

In a seventeenth aspect, a chip system is provided. The chip system includes at least one processor and an interface and is configured to support a network device in implementing functions involved in the second aspect, such as determining or processing at least one of data or information involved in the method. In a design, the chip system further includes a memory. The memory is configured to store necessary computer programs and data of the network device. The chip system may consist of a chip, or may also include a chip and other discrete devices.

In an eighteenth aspect, a computer program is provided. When running on a computer, the computer program enables the computer to perform the method according to the first aspect.

In a nineteenth aspect, a computer program is provided. When running on a computer, the computer program enables the computer to perform the method according to the second aspect.

### BRIEF DESCRIPTION OF DRAWINGS

In order to more clearly illustrate technical solutions in embodiments or a background of the present disclosure, accompanying drawings that need to be used in the embodiments or the background of the present disclosure will be described below.

FIG. 1 is a schematic architectural diagram of a communication system according to an embodiment of the present disclosure.

FIG. 2 is a schematic flowchart of a method for determining a precoding matrix for OAM according to an embodiment of the present disclosure.

FIG. 3 is a schematic diagram of an arrangement of antenna array units on a UCA according to an embodiment of the present disclosure.

FIG. 4 is a schematic diagram of an arrangement of selecting K target antenna array units according to an embodiment of the present disclosure.

FIG. 5 is a schematic flowchart of a method for determining a precoding matrix for OAM according to another embodiment of the present disclosure.

FIG. 6 is a schematic diagram of determining a relative position of a second communication device according to an embodiment of the present disclosure.

FIG. 7 is a schematic flowchart of a method for determining a precoding matrix for OAM according to another embodiment of the present disclosure.

FIG. 8 is a schematic flowchart of a method for determining a precoding matrix for OAM according to another embodiment of the present disclosure.

FIG. 9 is a schematic flowchart of a method for determining a precoding matrix for OAM according to another embodiment of the present disclosure.

FIG. 10 is a schematic flowchart of a method for determining a precoding matrix for OAM according to another embodiment of the present disclosure.

FIG. 11 is a schematic flowchart of a method for determining a precoding matrix for OAM according to another embodiment of the present disclosure.

FIG. 12 is a schematic structural diagram of a communication apparatus according to an embodiment of the present disclosure.

FIG. 13 is a schematic structural diagram of a communication apparatus according to an embodiment of the present disclosure.

FIG. 14 is a schematic structural diagram of a chip according to an embodiment of the present disclosure.

### DETAILED DESCRIPTION OF THE INVENTION

Examples will be illustrated in detail, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the present disclosure. Rather, they are merely instances of apparatuses and methods consistent with some aspects of the present disclosure as detailed in the appended claims.

Terms used in the embodiments of the present disclosure are merely for the purpose of describing specific embodiments, and are not intended to limit the embodiments of the present disclosure. Singular forms “one” and “the” used in the embodiments of the present disclosure and the appended claims are also intended to include plural forms unless the context clearly indicates other meanings. It is also to be understood that a term “and/or” as used in the present disclosure refers to and contains one listed item, or any or all possible combinations of more associated listed items.

It is to be understood that although terms first, second, third, etc. may be used to describe various information in the embodiments of the present disclosure, such information is not to be limited to these terms. These terms are merely used to distinguish the same type of information from each other. For example, without departing from the scope of the embodiments of the present disclosure, first information may also be referred to as second information, and similarly, the second information may also be referred to as the first information. Depending on the context, for example, a word “if” as used in the disclosure may be interpreted as “at the time” or “when” or “in response to determining”. For the purposes of brevity and case of understanding, terms “greater than” or “less than”, “above” or “below” are used in the disclosure to represent size relationships. However, it may be understood by those skilled in the art that the term “greater than” also covers the meaning of “greater than or equal to”, “less than” also covers the meaning of “less than or equal to”, the term “above” covers the meaning of “above or equal to”, and the term “below” also covers the meaning of “below or equal to”.

Due to a concave center and divergence pattern of an orbital angular momentum (OAM) beam, the reception of an electromagnetic wave in a far field is greatly troubled. In related art, the reception and detection of the OAM beam may be performed by receiving a whole circular beam using a large-aperture antenna array. However, due to the divergence of the OAM beam, a radius of a uniform circular array (UCA) of a receiving communication device will increase with an increase of a transmission distance, and it is too costly to design receiving antenna arrays of different sizes for different transmission distances. Thus, how to suppress the divergence angle of the OAM beam to reduce the impact of the transmission distance on the performance of an OAM communication system is a key to the application of OAM.

In order to better understand a method for determining a precoding matrix for OAM disclosed by an embodiment of the present disclosure, a communication system to which the embodiment of the present disclosure is applicable is first described below.

Please refer to FIG. 1. FIG. 1 is a schematic architecture diagram of a communication system according to an embodiment of the present disclosure. The communication system 100 may include but is not limited to a network device 101 and a terminal 102. The number and forms of the devices shown in FIG. 1 are merely for example and do not constitute a limitation of the embodiment of the present disclosure, and two or more network devices 101 and two or more terminals 102 may be included in actual applications. The communication system 100 shown in FIG. 1 takes an example of including a network device 101 and a terminal 102.

It needs to be noted that the technical solution of the embodiment of the present disclosure may be applied to various communication systems, for example, a long term evolution (LTE) system, a 5th generation (5G) mobile communication system, a 5G new radio (NR) system, or other novel mobile communication systems in the future. It further needs to be noted that a side link in the embodiment of the present disclosure may further be referred to as a sidelink or a direct communication link.

The network device 101 in the embodiment of the present disclosure is an entity on a network side and configured to transmit or receive a signal. For example, the network device 101 may be an evolved NodeB (eNB), a transmission reception point (TRP), a next generation NodeB (gNB) in an NR system, a base station in other future mobile communication systems, or an access node in a wireless fidelity (WiFi) system, etc. A specific technology and specific device form adopted for the network device is not limited by the embodiment of the present disclosure. The network device 101 provided by the embodiment of the present disclosure may include a central unit (CU) and a distributed unit (DU), where the CU may be referred to as a control unit. Adopting a CU-DU structure may divide a protocol layer of the network device 101, e.g., a base station. A function of part of the protocol layer is placed in the CU for a central control. A function of part or all of the rest of the protocol layer is distributed in the DU, and the DU is centrally controlled by the CU.

The terminal 102 in the embodiment of the present disclosure is an entity on a user side and configured to receive or transmit a signal, such as a mobile phone. The terminal 102 may also be referred to as a terminal, user equipment (UE), a mobile station (MS), a mobile terminal (MT), etc. The terminal 102 may be a car with a communication function, a smart car, a mobile phone, a wearable device, a pad, a computer with a wireless transceiving function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. A specific technology and specific device form adopted for the terminal 102 is not limited by the embodiment of the present disclosure.

In side link communications, four side link transmission modes exist. A side link transmission mode 1 and a side link transmission mode 2 are used for device-to-device (D2D) communications. A side link transmission mode 3 and a side link transmission mode 4 are used for vehicle to everything (V2X) communications. When the side link transmission mode 3 is used, resource allocation is scheduled by the network device 101. For example, the network device 101 may send resource allocation information to the terminal 102, and then the terminal 102 allocates resources to another terminal, so that this another terminal may send information to the network device 101 through the allocated resources. In the V2X communications, a terminal with a better signal or higher reliability may be used as the terminal 102. A first terminal referred to in the embodiment of the present disclosure may refer to this terminal 102, and a second terminal may refer to this another terminal.

It may be understood that the communication system 100 described in the embodiment of the present disclosure is to more clearly illustrate the technical solution of the embodiment of the present disclosure, and does not constitute a limitation on the technical solution provided by the embodiment of the present disclosure. It may be known to those ordinarily skilled in the art that with the evolution of a system architecture and the emergence of new service scenarios, the technical solution provided by the embodiment of the present disclosure is also suitable for similar technical problems.

It needs to be noted that a method for determining a precoding matrix for OAM according to any of the embodiments in the present disclosure may be performed alone, or performed in conjunction with possible implementation methods in other embodiments, and may further be performed in conjunction with any of technical solutions in related art.

A method for determining a precoding matrix for OAM and an apparatus thereof according to the present disclosure are introduced in detail below in conjunction with accompanying drawings.

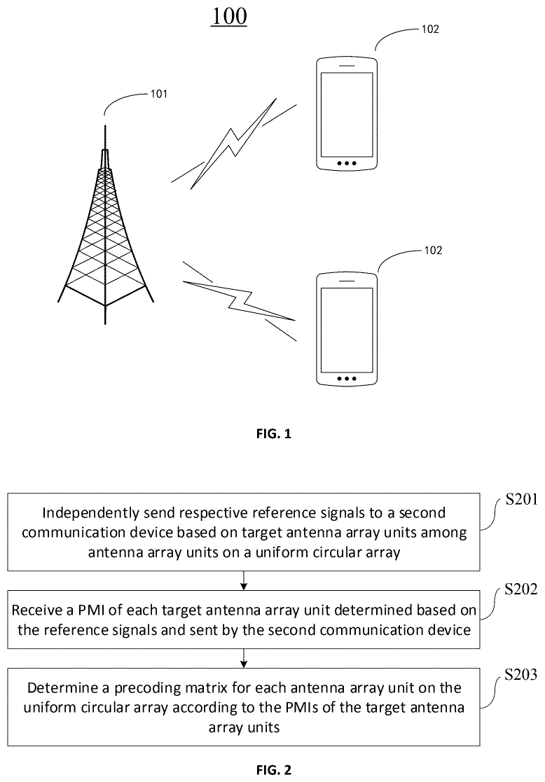

Please refer to FIG. 2. FIG. 2 is a schematic flowchart of a method for determining a precoding matrix for orbital angular momentum (OAM) according to the present disclosure. The method is performed by a first communication device. The method for determining the precoding matrix for the OAM includes, but is not limited to, steps S201, S202 and S203.

In step S201, respective reference signals are independently sent to a second communication device based on target antenna array units among antenna array units on a uniform circular array (UCA).

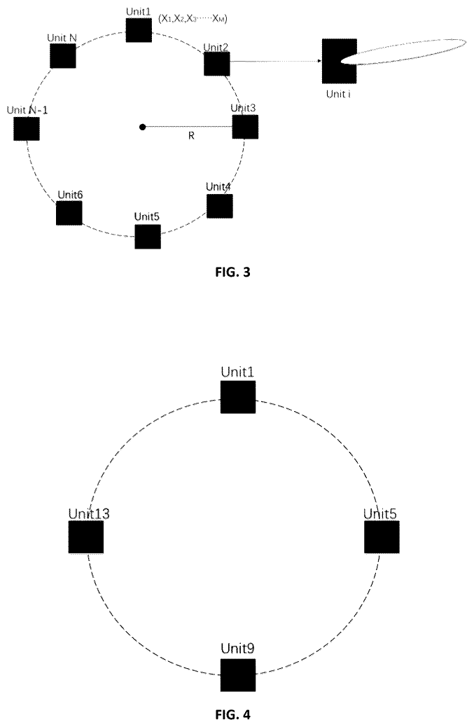

As shown in FIG. 3, N antenna array units may be arranged on the UCA, where N is a positive integer greater than or equal to two. The N antenna array units may be arranged uniformly or non-uniformly on the UCA. For example, the N antenna array units may be grouped and arranged symmetrically on the UCA, where groups may be uniformly or non-uniformly arranged on the UCA.

In an example, the first communication device may independently send respective reference signals to the second communication device based on at least two antenna array units among the antenna array units. In the embodiment of the present disclosure, the at least two antenna array units are referred to as target antenna array units. It needs to be noted that this definition is applicable to the following embodiments and will not be described subsequently.

In an example, the first communication device may be a network device such as a base station, and the second communication device may be a relay base station or a terminal.

The first communication device may select K antenna array units from the N antenna array units on the UCA and send respective reference signals to the second communication device through the K antenna array units. The selected K antenna array units are the target antenna array units.

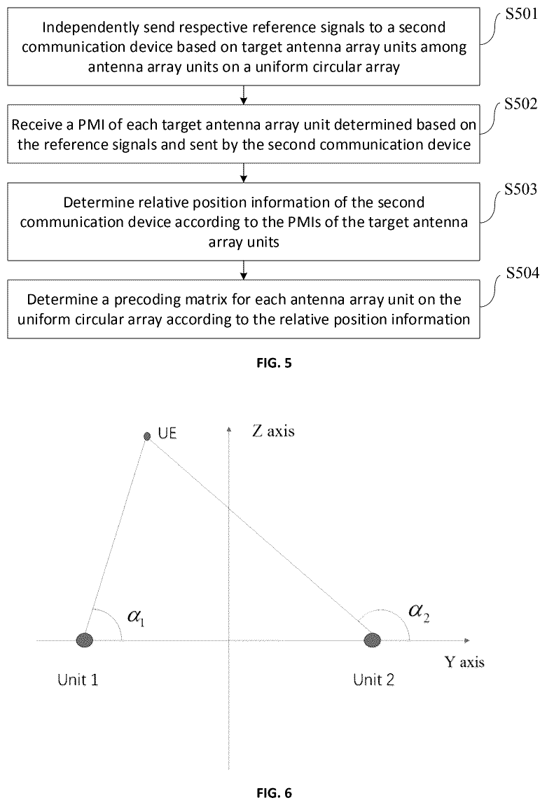

In some implementations, the K antenna array units may be selected uniformly from the UCA, or may be selected according to an indication or pre-configuration. As shown in FIG. 4, 16 antenna array units are arranged on the UCA, which may be labeled as Unit 1 to Unit 16. The first communication device may select 4 units uniformly from the 16 units, i.e., K=4, i.e., Unit 1, Unit 5, Unit 9, and Unit 13 are selected.

In other implementations, K is a positive integer, and a value of K is greater than or equal to 2 and less than or equal to N.

In other implementations, the first communication device, after selecting the K units, may configure a reference signal for each of the K units, and send the reference signals to the second communication device after the configuration is completed.

It needs to be noted that the reference signals are used for a channel estimation by the second communication device to determine precoding matrix indexs (PMIs) of the units.

In step S202, a PMI of each target antenna array unit determined based on the reference signals and sent by the second communication device is received.

In the embodiment of the present disclosure, the second communication device may perform the channel estimation based on the reference signals of the target antenna array units, obtain first channel information based on the channel estimation, and further determine the PMIs of the target antenna array units according to the first channel information. After determining the PMIs of the target antenna array units, the second communication device sends the PMIs of the target antenna array units to the first communication device, and accordingly the first communication device may receive the PMI of each target antenna array unit sent by the second communication device.

It needs to be noted that the second communication device may determine the first channel information corresponding to the target antenna array unit according to the reference signal, and determine an optimal codeword of the target antenna array unit from a preset codebook. Further, the PMI of the target antenna array unit is determined according to the optimal codeword of the target antenna array unit. The PMI may be configured to indicate the optimal codeword and may be an index value of the optimal codeword.

The preset codebook may be a one-dimensional codebook, or a two-dimensional codebook, or a four-dimensional codebook, which is not limited in the embodiment of the present disclosure. In the embodiment of the present disclosure, the optimal codeword may be selected from the preset codebook based on a maximum channel capacity, that is, transmitting based on the optimal codeword may maximize a channel capacity, and can improve the efficiency and accuracy of transmission.

In step S203, a precoding matrix for each antenna array unit on the uniform circular array is determined according to the PMIs of the target antenna array units.

In the embodiment of the present disclosure, the N antenna array units are arranged on the UCA, and the arrangement of the N antenna array units has a certain regularity, so that the precoding matrix for each antenna array unit on the UCA may be determined based on the PMIs of the selected K target antenna array units. In some implementations, the precoding matrix for each antenna array unit on the UCA may be determined based on configuration information of the UCA and the PMIs of the target antenna array units. The configuration information of the UCA may include a radius of the UCA, a number of the antenna array units on the UCA, position line information of the antenna array units on the UCA, etc.

In some other implementations, a correlation situation among the N antenna array units may be preconfigured, and after the precoding matrices of the target antenna array units are determined according to the PMIs of the target antenna array units, the precoding matrix for each antenna array unit on the UCA is determined based on the correlation situation. For example, antenna array units near the target antenna array units may utilize the same precoding matrices as the target antenna array units. Alternatively, a phase shift transformation may be performed on the same precoding matrices of the target antenna array units, so as to obtain precoding matrices of antenna array units near the target antenna array units. Alternatively, the precoding matrices may be correlated in advance, and after the same precoding matrices of the target antenna array units are determined, the precoding matrices of the antenna array units near the target antenna array units are determined based on a correlation among the precoding matrices.

In the embodiment of the present disclosure, respective reference signals are independently sent to the second communication device based on the target antenna array units among the antenna array units on the UCA, the PMI of each target antenna array unit is received, and the precoding matrix for each antenna array unit on the UCA is determined according to the PMIs of the target antenna array units. In the present disclosure, respective precoding matrix for each unit on the UCA is obtained by interacting with the second communication device through part of the antenna array units, and information or data transmission is performed with the second communication device through the selected precoding matrix, resulting in a best transmission performance of the antenna array units. Further, the precoding matrices of the antenna array units may enable beamforming of the antenna array units to produce an effect of convergence toward a center in the air, thus facilitating the suppression of a divergence angle of an OAM beam, so that a problem of being unable to transmit over a long distance due to a larger divergence angle of the OAM beam may be solved to a certain extent.

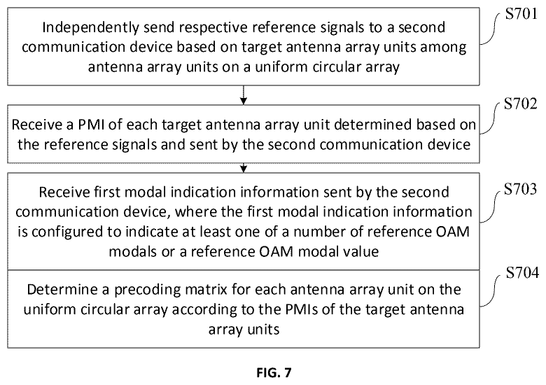

Please refer to FIG. 5. FIG. 5 is a schematic flowchart of a method for determining a precoding matrix for OAM according to the present disclosure. The method is performed by a first communication device. The method for determining the precoding matrix for the OAM includes, but is not limited to, steps S501, S502, S503 and S504.

In step S501, respective reference signals are independently sent to a second communication device based on target antenna array units among antenna array units on a uniform circular array (UCA).

In step S502, a PMI of each target antenna array unit determined based on the reference signals and sent by the second communication device is received.

Specific descriptions of step S501-step S502 may refer to the disclosure of relevant contents in the above embodiments, and will not be repeated.

In step S503, relative position information of the second communication device is determined according to the PMIs of the target antenna array units.

In an example, unit position information of the target antenna array units may be determined according to configuration information of the UCA. Further, direction angles between the target antenna array units and the second communication device may be determined according to the PMIs, and the relative position information of the second communication device is determined according to the direction angles, the configuration information of the UCA, and the unit position information.

In an example, the configuration information of the UCA may include one or more of at least one of a radius of the UCA, a number of the antenna array units arranged on the UCA, or unit position information of the arranged antenna array units.

In an example, the PMI may indicate the direction angle between the target antenna array unit and the second communication device.

In the embodiment of the present disclosure, a coordinate system may be established with a center position of the UCA on the first communication device as a center of a circle.

A process of determining the relative position information of the second communication device is explained below using two target antenna array units as an example.

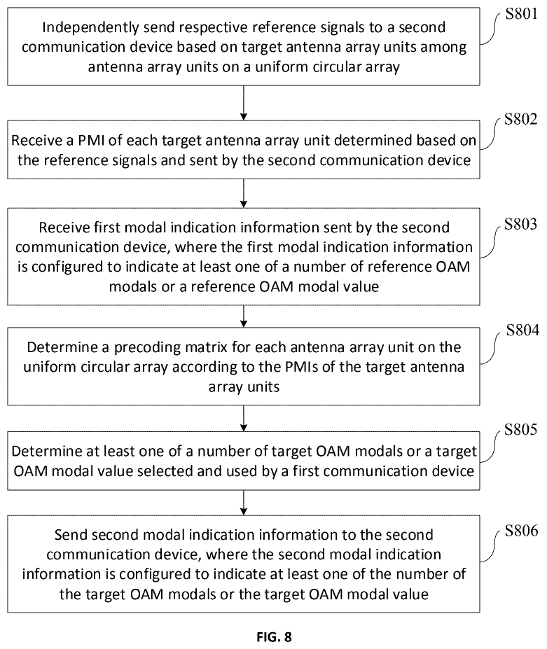

As shown in FIG. 6, the two target antenna array units are Unit 1 and Unit 2. Unit 1 and Unit 2 are located on a coordinate axis of the coordinate system. A distance between Unit 1 and Unit 2 is a diameter of the UCA, i.e., 2Rt. Further, respective direction angles of Unit 1 and Unit 2 to the second communication device (UE) in a vertical dimension are determined to be α₁, α₂ respectively according to respective PMIs of Unit 1 and Unit 2.

A Z-axis coordinate of the second communication device is:

$${z}_{UE} = \frac{2 * Rt * tan ( {α}_{1} ) tan ( {α}_{2} )}{tan ( {α}_{2} ) - tan ( {α}_{1} )} .$$

A Y-axis coordinate of the second communication device is:

$${y}_{UE} = {z}_{UE} * \frac{1}{tan ( {α}_{1} )} - Rt .$$

An X-axis coordinate of the second communication device is:

$${x}_{UE} = {z}_{UE} * \frac{1}{tan ( {α}_{2} )} - Rt .$$

In the embodiment of the present disclosure, the relative position information (x, y, z) of the second communication device may be obtained through the above-mentioned calculation process. It needs to be noted that the relative position information of the second communication device may represent a center position of the UCA of the second communication device, i.e., the determined relative position of the second communication device may be the center position of the UCA of the second communication device.

In step S504, a precoding matrix for each antenna array unit on the uniform circular array is determined according to the relative position information.

In the embodiment of the present disclosure, after the relative position information of the second communication device is determined, the precoding matrix for each antenna array unit on the UCA may be determined based on the relative position information and configuration information of the UCA.

The configuration information of the UCA may include a radius of the UCA, a number of the antenna array units on the UCA, position line information of the antenna array units on the UCA, etc.

For example, in an example, the preset codebook is a two-dimensional discrete Fourier transform (DFT) codebook, and a process of determining the precoding matrix for each antenna array unit includes:
a first-dimension vector:

$${v}_{{m}_{1}} = [ \begin{matrix}1 & {e}^{j \frac{2 π {m}_{1}}{{O}_{1} {N}_{1}}} & … & {e}^{j \frac{2 π {m}_{1} ( {N}_{1} - 1 )}{{O}_{1} {N}_{1}}} ]\end{matrix}$$

a second-dimension vector:

$${u}_{{m}_{2}} = [ \begin{matrix}1 & {e}^{j \frac{2 π {m}_{2}}{{O}_{2} {N}_{2}}} & … & {e}^{j \frac{2 π {m}_{2} ( {N}_{2} - 1 )}{{O}_{2} {N}_{2}}} ]\end{matrix}$$

where N₁, N₂ represent a number of antenna arrays in a first dimension and a number of antenna arrays in a second dimension respectively, O₁, O₂ represent oversampling factors, and m₁, m₂ represent a beam index in the first-dimension and a beam index in the second-dimension respectively.

It needs to be noted that m₁, m₂ are the beam index in the first-dimension and the beam index in the second-dimension respectively, and may be obtained by the first communication device by performing operation on the relative position information and the configuration information of the UCA through a built-in algorithm.

Further, the precoding matrix for the antenna array unit may be obtained from a Kronecker product of the first-dimension vector and the second-dimension vector.

In the embodiment of the present disclosure, respective reference signals are independently sent to the second communication device based on the target antenna array units among the antenna array units on the uniform circular array, the PMI of each target antenna array unit is received, the relative position information of the second communication device is determined according to the PMIs of the target antenna array units, and the precoding matrix for each antenna array unit on the UCA is determined according to the relative position information. In the present disclosure, respective precoding matrix for each unit on the UCA is obtained by interacting with the second communication device through part of the antenna array units, and information or data transmission is performed with the second communication device through the selected precoding matrix, resulting in a best transmission performance of the antenna array units. Further, in the process of determining the precoding matrix for each antenna array unit on the UCA, the relative position information of the second communication device is taken into account, in this way, beamforming of the antenna array units is enabled to be inclined to the second communication device, thus facilitating the suppression of a divergence angle of an OAM beam, so that a problem of being unable to transmit over a long distance due to a larger divergence angle of the OAM beam is solved to a certain extent.

Please refer to FIG. 7. FIG. 7 is a schematic flowchart of a method for determining a precoding matrix for OAM according to the present disclosure. The method is performed by a first communication device. The method for determining the precoding matrix for the OAM includes, but is not limited to, steps S701, S702, S703 and S704.

In step S701, respective reference signals are independently sent to a second communication device based on target antenna array units among antenna array units on a uniform circular array (UCA).

In step S702, a PMI of each target antenna array unit determined based on the reference signals and sent by the second communication device is received.

Specific descriptions of step S701-step S702 may refer to the disclosure of relevant contents in the above-mentioned embodiments, and will not be repeated.

In step S703, first modal indication information sent by the second communication device is received, where the first modal indication information is configured to indicate at least one of a number of reference OAM modals or a reference OAM modal value.

It needs to be noted that the number of the reference OAM modals and the reference OAM modal value are determined by the second communication device based on the PMIs and the first channel information of the target antenna array units. The second communication device may perform a channel estimation based on the reference signals of the target antenna array units, obtain the first channel information based on the channel estimation and determine the PMIs of the target antenna array units according to the first channel information. Further, the second communication device may assume that the first communication device performs subsequent transmission based on the target antenna array units, and determine at least one of a number of reference OAM modals or a reference OAM modal value of the first communication device according to the PMIs and the first channel information of the target antenna array units.

The second communication device may send the first modal indication information to the first communication device, and the first modal indication information is configured to indicate at least one of the number of the reference OAM modals or the reference OAM modal value. Accordingly, the first communication device may receive the first modal indication information, and determine at least one of the number of the reference OAM modals or the reference OAM modal value according to the first modal indication information. In an example, the first communication device may determine at least one of a number of target OAM modals or a target OAM modal value selected and used by the first communication device from at least one of the number of the reference OAM modals or the reference OAM modal value indicated by the first modal indication information, so as to further determine an OAM beamforming coefficient of each antenna array unit based on the target OAM modal value.

In step S704, a precoding matrix for each antenna array unit on the uniform circular array is determined according to the PMIs of the target antenna array units.

Specific descriptions of step S704 may refer to the disclosure of relevant contents in the above-mentioned embodiments, and will not be repeated.

In the present disclosure, in the process of determining the precoding matrix for each antenna array unit on the UCA, the relative position information of the second communication device is taken into account, in this way, beamforming of the antenna array units is enabled to be inclined to the second communication device, thus facilitating the suppression of a divergence angle of an OAM beam, so that a problem of being unable to transmit over a long distance due to a larger divergence angle of the OAM beam may be solved. In addition, information or data transmission is performed with the second communication device through the selected precoding matrix, resulting in a best transmission performance of the antenna array units.

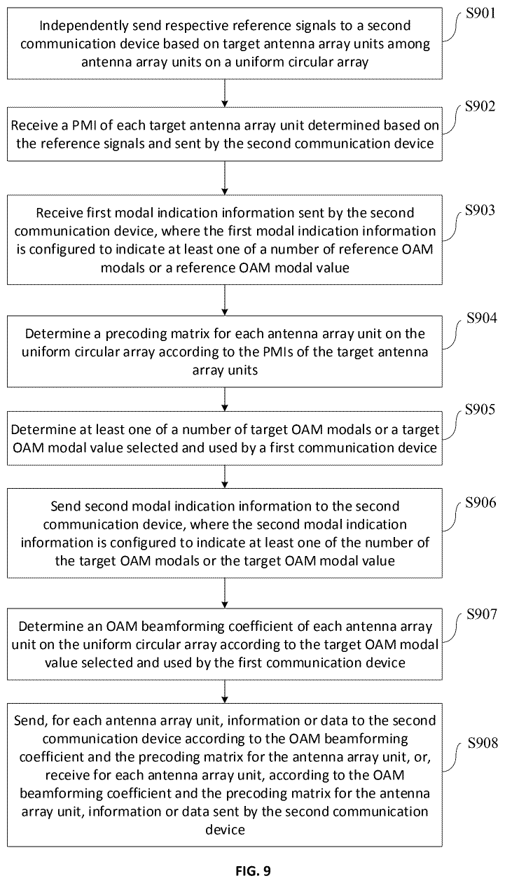

Please refer to FIG. 8. FIG. 8 is a schematic flowchart of a method for determining a precoding matrix for OAM according to the present disclosure. The method is performed by a first communication device. The method for determining the precoding matrix for the OAM includes, but is not limited to, steps S801 to S806.

In step S801, respective reference signals are independently sent to a second communication device based on target antenna array units among antenna array units on a uniform circular array (UCA).

In step S802, a PMI of each target antenna array unit determined based on the reference signals and sent by the second communication device is received.

In step S803, first modal indication information sent by the second communication device is received, where the first modal indication information is configured to indicate at least one of a number of reference OAM modals or a reference OAM modal value.

Specific descriptions of step S801 to step S803 may refer to the disclosure of relevant contents in the above-mentioned embodiments, and will not be repeated.

In step S804, a precoding matrix for each antenna array unit on the uniform circular array is determined according to the PMIs of the target antenna array units.

Specific descriptions of step S804 may refer to the disclosure of relevant contents in the above-mentioned embodiments, and will not be repeated.

In step S805, at least one of a number of target OAM modals or a target OAM modal value selected and used by the first communication device is determined.

Before transmission between the first communication device and the second communication device, at least one of the number of the target OAM modals or the target OAM modal value selected and used by the first communication device needs to be determined, and further the first communication device may determine an OAM beamforming coefficient of each antenna array unit based on the selected and used target OAM modal value. The first communication device may perform beamforming respectively based on the OAM beamforming coefficients of the antenna array units so as to transmit information or data with the second communication device through the antenna array units.

In an implementation, the first communication device may determine at least one of the number of the target OAM modals or the target OAM modal value from at least one of the number of the reference OAM modals or the reference OAM modal value indicated by the second communication device. That is, the first communication device may determine at least one of the number of the reference OAM modals or the reference OAM modal value according to the first modal indication information, and determine at least one of the number of the target OAM modals or the target OAM modal value from at least one of the number of the reference OAM modals or the reference OAM modal value.

In another implementation, the first communication device may re-obtain at least one of the number of the target OAM modals or the target OAM modal value in a case where at least one of the number of the reference OAM modals or the reference OAM modal value indicated by the second communication device does not meet transmission requirements.

In an example, the first communication device may encode the reference signals corresponding to each antenna array unit according to the precoding matrix for each antenna array unit on the UCA, and send the encoded reference signals to the second communication device for a channel estimation, so as to obtain second channel information corresponding to the antenna array units. Further, the first communication device may receive the second channel information corresponding to the antenna array units fed back by the second communication device. The first communication device determines at least one of the number of the target OAM modals or the target OAM modal value based on the second channel information corresponding to the antenna array units. In an example, a set of OAM modal values is preconfigured, and each OAM modal value in the set corresponds to adapted channel information. The first communication device, after determining the second channel information, may determine, from the set of OAM modal values, a suitable OAM modal value as the target OAM modal value based on the second channel information, and further, the first communication device may determine the number of the target OAM modals according to a number of the suitable OAM modal values.

In step S806, second modal indication information is sent to the second communication device, where the second modal indication information is configured to indicate at least one of the number of the target OAM modals or the target OAM modal value.

After the target OAM modal value and the number of the target OAM modals are determined, the first communication device may indicate at least one of the target OAM modal value or the number of the target OAM modals to the second communication device, so as to enable the second communication device to determine the OAM beamforming coefficient of the antenna array units on its own UCA based on the number of the target OAM modals. In an example, at least one of the target OAM modal value or the number of the target OAM modals may be indicated to the second communication device through the second modal indication information.

In the present disclosure, in the process of determining the precoding matrix for each antenna array unit on the UCA, the relative position information of the second communication device is taken into account, in this way, beamforming of the antenna array units is enabled to be inclined to the second communication device, thus facilitating the suppression of a divergence angle of an OAM beam, so that a problem of being unable to transmit over a long distance due to a larger divergence angle of the OAM beam may be solved. In addition, information or data transmission is performed with the second communication device through the selected precoding matrix, resulting in a best transmission performance of the antenna array units.

Please refer to FIG. 9. FIG. 9 is a schematic flowchart of a method for determining a precoding matrix for OAM according to the present disclosure. The method is performed by a first communication device. The method for determining the precoding matrix for the OAM includes, but is not limited to, steps S901 to S908.

In step S901, respective reference signals are independently sent to a second communication device based on target antenna array units among antenna array units on a uniform circular array (UCA).

In step S902, a PMI of each target antenna array unit determined based on the reference signals and sent by the second communication device is received.

In step S903, first modal indication information sent by the second communication device is received, where the first modal indication information is configured to indicate at least one of a number of reference OAM modals or a reference OAM modal value.

In step S904, a precoding matrix for each antenna array unit on the uniform circular array is determined according to the PMIs of the target antenna array units.

In step S905, at least one of a number of target OAM modals or a target OAM modal value selected and used by the first communication device is determined.

In step S906, second modal indication information is sent to the second communication device, where the second modal indication information is configured to indicate at least one of the number of the target OAM modals or the target OAM modal value.

Specific descriptions of step S901 to step S906 may refer to the disclosure of relevant contents in the above-mentioned embodiments, and will not be repeated.

In step S907, an OAM beamforming coefficient of each antenna array unit on the uniform circular array is determined according to the target OAM modal value selected and used by the first communication device.

In the embodiment of the present disclosure, the first communication device may determine phase information of an OAM beamforming vector of any antenna array unit based on the target OAM modal value, and further determine an OAM beamforming coefficient of the any antenna array unit according to the phase information of the OAM beamforming vector.

For example, Xₙ may represent an OAM beamforming coefficient of an n^{th} unit: Xₙ=e^{jφ}^{ₙ}, where j represents an imaginary unit, and φₙ represents phase information of an OAM beamforming vector of the n^{th} unit, which may be represented as:

$${φ}_{n} = \frac{2 π l}{N} n ,$$

where/represents an OAM modal value, and N represents the number of the units.

In step S908, for each antenna array unit, information or data is sent to the second communication device according to the OAM beamforming coefficient and the precoding matrix for the antenna array unit; or, information or data sent by the second communication device is received according to the OAM beamforming coefficient and the precoding matrix for the antenna array unit.

In an example, a same precoding matrix is used for downlink transmission and uplink reception based on uplink and downlink beam reciprocity.

After the OAM beamforming coefficient of each antenna array unit is determined, in a case of uplink transmission by the first communication device, the information or data sent by the second communication device may be received based on the OAM beamforming coefficient and the precoding matrix for the antenna array unit.

In a case of downlink transmission by the first communication device, information sent to the second communication device may be pre-encoded based on the OAM beamforming coefficient and the precoding matrix for the antenna array unit, and pre-encoded information or data may be sent to the second communication device. In an example, information or data to be transmitted may be multiplied by the OAM beamforming coefficient and then multiplied by the precoding matrix for the antenna array unit, so as to obtain the precoded information or data. In an example, the information or data to be transmitted may be multiplied by the precoding matrix for the antenna array unit and then multiplied by the OAM beamforming coefficient, so as to obtain the precoded information or data.

In the present disclosure, in the process of determining the precoding matrix for each antenna array unit on the UCA, the relative position information of the second communication device is taken into account, in this way, beamforming of the antenna array units is enabled to be inclined to the second communication device, thus facilitating the suppression of a divergence angle of an OAM beam, so that a problem of being unable to transmit over a long distance due to a larger divergence angle of the OAM beam may be solved. In addition, information or data transmission is performed with the second communication device through the selected precoding matrix, improving a transmission performance of the antenna array units.

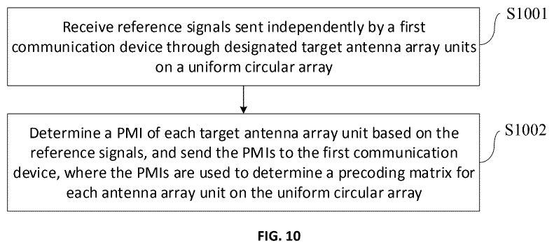

Please refer to FIG. 10. FIG. 10 is a schematic flowchart of a method for determining a precoding matrix for OAM according to the present disclosure. The method is performed by a second communication device. The method for determining the precoding matrix for the OAM includes, but is not limited to, steps S1001 and S1002.

In step S1001, reference signals sent independently by a first communication device through designated target antenna array units on a uniform circular array (UCA) are received.

In an example, the first communication device may independently send respective reference signals to the second communication device based on at least two target antenna array units among the antenna array units. Accordingly, the second communication device may receive reference signals sent by the at least two target antenna array units.

In an example, before receiving the reference signals, the second communication device may receive configuration information for the reference signal corresponding to each target antenna array unit and sent by the first communication device. The configuration information may configure a time-frequency position where the reference signal of each target antenna array unit is located, a sending cycle for the reference signal of each target antenna array unit, a number of times of sending for the reference signal of each target antenna array unit, etc.

Further, the second communication device may receive, based on the configuration information for the reference signal, the reference signal sent by each target antenna array unit. For example, the reference signal may be received in the time-frequency position indicated by the configuration information.

Descriptions about arranging the antenna array units on the UCA and selecting the target antenna array units may refer to the disclosure of relevant contents in the above-mentioned embodiments, and will not be repeated.

In step S1002, a PMI of each target antenna array unit is determined based on the reference signals and is sent to the first communication device, where the PMI is used to determine a precoding matrix for each antenna array unit on the uniform circular array.

In an implementation, the second communication device may perform a channel estimation based on the reference signals of the target antenna array units, obtain first channel information based on the channel estimation, and further determine the PMIs of the target antenna array units according to the first channel information. After determining the PMIs of the target antenna array units, the second communication device sends the PMIs of the target antenna array units to the first communication device, and accordingly the first communication device may receive the PMI of each target antenna array unit sent by the second communication device.

In an example, the second communication device may determine the first channel information corresponding to the target antenna array unit according to the reference signal, and determine an optimal codeword of the target antenna array unit from a preset codebook. Further, the PMI of the target antenna array unit is determined according to the optimal codeword of the target antenna array unit. The PMI may be configured to indicate the optimal codeword and may be an index value of the optimal codeword.

The preset codebook may be a one-dimensional codebook, or a two-dimensional codebook, or a four-dimensional codebook, which is not limited in the embodiment of the present disclosure. In the embodiment of the present disclosure, the optimal codeword may be selected from the preset codebook based on a maximum channel capacity, that is, transmitting based on the optimal codeword may maximize a channel capacity, and can improve the efficiency and accuracy of transmission.

The process that the first communication device determines the precoding matrix for each antenna array unit based on the PMIs of the target antenna array units may refer to the disclosure of relevant contents in the above-mentioned embodiments, and will not be repeated. In the present disclosure, respective precoding matrix for each unit on the UCA is obtained by interacting with the second communication device through part of the antenna array units, and information or data transmission is performed with the second communication device through the selected precoding matrix, resulting in a best transmission performance of the antenna array units. Further, the precoding matrices of the antenna array units may enable beamforming of the antenna array units to produce an effect of convergence toward a center in the air, thus facilitating the suppression of a divergence angle of an OAM beam, and solving, to a certain extent, a problem of being unable to transmit over a long distance due to a larger divergence angle of the OAM beam.

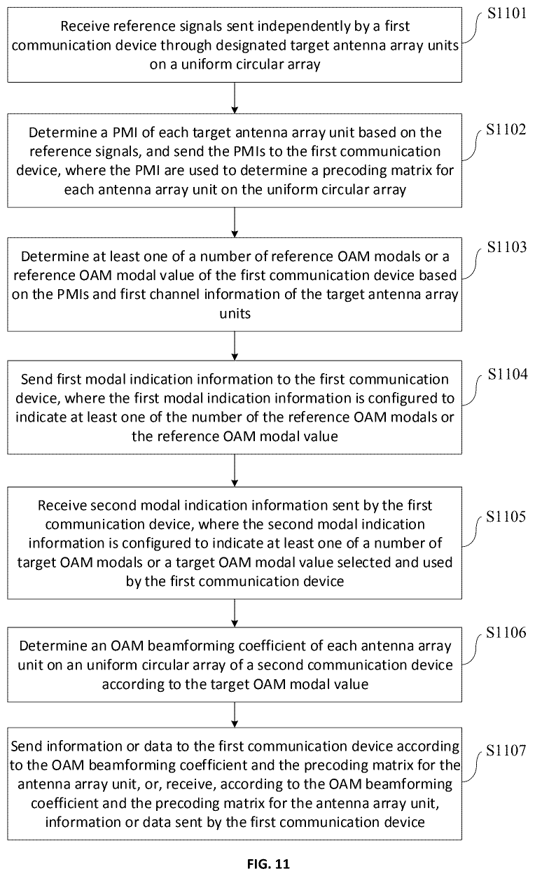

Please refer to FIG. 11. FIG. 11 is a schematic flowchart of a method for determining a precoding matrix for OAM according to the present disclosure. The method is performed by a second communication device. The method for determining the precoding matrix for the OAM includes, but is not limited to, steps S1101 to S1107.

In step S1101, reference signals sent independently by a first communication device through designated target antenna array units on a uniform circular array (UCA) are received.

In step S1102, a PMI of each target antenna array unit is determined based on the reference signals and is sent to the first communication device, where the PMI is used to determine a precoding matrix for each antenna array unit on the uniform circular array.

In step S1103, at least one of a number of reference OAM modals or a reference OAM modal value of the first communication device is determined based on the PMIs and first channel information of the target antenna array units.

The second communication device may perform a channel estimation based on the reference signals of the target antenna array units, obtain the first channel information based on the channel estimation and determine the PMIs of the target antenna array units according to the first channel information. Further, the second communication device may assume that the first communication device performs subsequent transmission based on the target antenna array units, and determine at least one of the number of the reference OAM modals or the reference OAM modal value of the first communication device according to the PMIs and first channel information of the target antenna array units.

The second communication device may send first modal indication information to the first communication device, and the first modal indication information is configured to indicate at least one of the number of the reference OAM modals or the reference OAM modal value. Accordingly, the first communication device may receive the first modal indication information, and determine at least one of the number of the reference OAM modals or the reference OAM modal value according to the first modal indication information. In an example, the first communication device may determine at least one of a number of target OAM modals or a target OAM modal value selected and used by the first communication device from at least one of the number of the reference OAM modals or the reference OAM modal value indicated by the first modal indication information, so as to further determine an OAM beamforming coefficient of each antenna array unit based on the target OAM modal value.

In step S1104, first modal indication information is sent to the first communication device, where the first modal indication information is configured to indicate at least one of the number of the reference OAM modals or the reference OAM modal value.

In step S1105, second modal indication information sent by the first communication device is received, where the second modal indication information is configured to indicate at least one of a number of target OAM modals or a target OAM modal value selected and used by the first communication device.

In an implementation, the first communication device may determine at least one of the number of the target OAM modals or the target OAM modal value from at least one of the number of the reference OAM modals or the reference OAM modal value sent by the second communication device. Specific descriptions may refer to the disclosure of relevant contents in the above-mentioned embodiments, and will not be repeated.

In an implementation, the first communication device may encode the reference signal corresponding to each antenna array unit according to the precoding matrix for each antenna array unit on the UCA, and the second communication device may receive the encoded reference signals and perform a channel estimation based on the encoded reference signals to obtain second channel information corresponding to the antenna array units. Further, the second communication device feeds the second channel information corresponding to the antenna array units back to the first communication device. The first communication device determines at least one of the number of the target OAM modals or the target OAM modal value based on the second channel information corresponding to the antenna array units. A process of determining at least one of the number of the target OAM modals or the target OAM modal value may refer to the disclosure of relevant contents in the above-mentioned embodiment, and will not be repeated.

Further, the second communication device may receive the second modal indication information sent by the first communication device, where the second modal indication information is configured to indicate at least one of the number of the target OAM modals or the target OAM modal value selected and used by the first communication device.

In step S1106, an OAM beamforming coefficient of each antenna array unit on the uniform circular array of the second communication device is determined according to the target OAM modal value.

In the embodiment of the present disclosure, the second communication device may determine phase information of an OAM beamforming vector of any antenna array unit based on the target OAM modal value, and further determine the OAM beamforming coefficient of the any antenna array unit according to the phase information of the OAM beamforming vector.

In step S1107, information or data is sent to the first communication device according to the OAM beamforming coefficient and the precoding matrix for the antenna array unit; alternatively, information or data sent by the first communication device is received according to the OAM beamforming coefficient and the precoding matrix for the antenna array unit.

In an example, a same precoding matrix is used for downlink transmission and uplink reception based on uplink and downlink beam reciprocity. In an example, the second communication device may determine the precoding matrix for each antenna array unit on the UCA of the second communication device using the same process as the first communication device, or may pre-configure the precoding matrix for each antenna array unit on the UCA of the second communication device.

After the OAM beamforming coefficient of each antenna array unit is determined, in a case of downlink transmission by the second communication device, the information sent to the first communication device may be received based on the OAM beamforming coefficient and the precoding matrix for the antenna array unit.

In a case of uplink transmission by the second communication device, information or data to be transmitted by the second communication device may be encoded based on the OAM beamforming coefficient and the precoding matrix for the antenna array unit. In an example, information or data to be transmitted may be multiplied by the OAM beamforming coefficient and then multiplied by the precoding matrix for the antenna array unit, so as to obtain the precoded information or data. In an example, the information or data to be transmitted may be multiplied by the precoding matrix for the antenna array unit and then multiplied by the OAM beamforming coefficient, so as to obtain the precoded information or data.

In the present disclosure, in the process of determining the precoding matrix for each antenna array unit on the UCA, the relative position information of the second communication device is taken into account, in this way, beamforming of the antenna array units is enabled to be inclined to the second communication device, thus facilitating the suppression of a divergence angle of an OAM beam, so that a problem of being unable to transmit over a long distance due to a larger divergence angle of the OAM beam may be solved. In addition, information or data transmission is performed with the second communication device through the selected precoding matrix, and as the precoding matrix for the antenna array unit may make the best transmission performance of the antenna array unit, the transmission distance may be improved.

In the embodiments of the present disclosure, the methods according to the embodiments of the present disclosure are described from the perspectives of the first communication device and the second communication device respectively. In order to implement the functions in the methods according to the embodiments of the present disclosure, the first communication device and the second communication device may include a hardware structure and a software module to implement the above-mentioned functions in the form of the hardware structure, the software module, or a hardware structure plus a software module. A certain function of the above-mentioned functions may be executed in the form of the hardware structure, the software module or the hardware structure plus the software module.

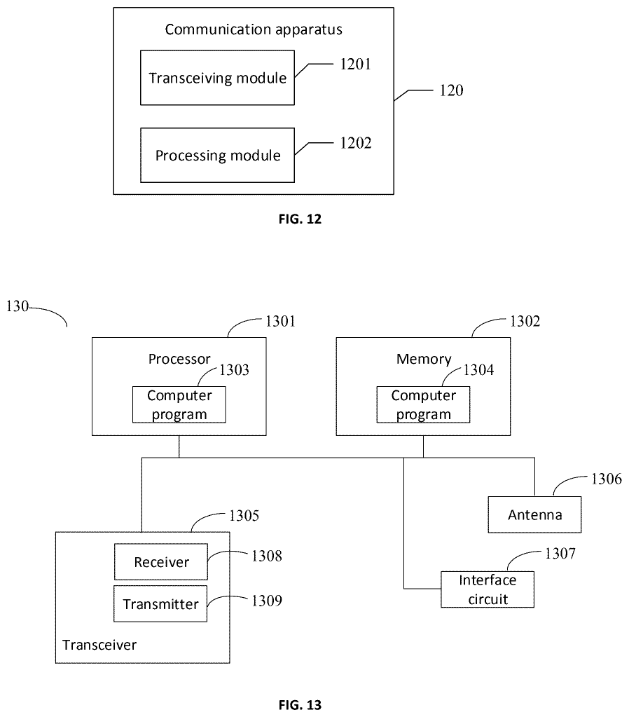

Please refer to FIG. 12 which is a schematic structural diagram of a communication apparatus 120 according to an embodiment of the present disclosure. The communication apparatus 120 shown in FIG. 12 may include a transceiving module 1201 and a processing module 1202. The transceiving module 1201 may include at least one of a sending module (not shown) or a receiving module (not shown), the sending module is configured to implement a sending function, the receiving module is configured to implement a receiving function, and the transceiving module 1201 may implement at least one of a sending function or a receiving function.

The communication apparatus 120 may be a first communication device. The first communication device is a network device, or may be an apparatus in a network device, or may be an apparatus capable of being used in conjunction with a network device. Alternatively, the communication apparatus 120 may be a second communication device. The second communication device may a network device, or may be a terminal. The communication apparatus 120 may also be an apparatus in a network device, or an apparatus capable of being used in conjunction with a network device. The communication apparatus 120 may also be an apparatus in a terminal, or an apparatus capable of being used in conjunction with a terminal.

In a case where the communication apparatus 120 is the first communication device, the transceiving module 1201 is configured to independently send respective reference signals to a second communication device based on target antenna array units among antenna array units on a uniform circular array (UCA), and receive a precoding matrix index (PMI) of each target antenna array unit determined based on the reference signals and sent by the second communication device. The processing module 1202 is configured to determine a precoding matrix for each antenna array unit on the uniform circular array according to the PMIs of the target antenna array units.

In an example, the processing module 1202 is further configured to determine relative position information of the second communication device according to the PMIs of the target antenna array units, and determine the precoding matrix for each antenna array unit on the uniform circular array according to the relative position information.

In an example, the processing module 1202 is further configured to determine unit position information of the target antenna array units according to configuration information of the uniform circular array, determine direction angles between the target antenna array units and the second communication device according to the PMIs, and determine the relative position information of the second communication device according to the direction angles, the configuration information of the uniform circular array, and the unit position information.

In an example, the transceiving module 1201 is further configured to receive first modal indication information sent by the second communication device. The first modal indication information is configured to indicate at least one of a number of reference OAM modals or a reference OAM modal value. The number of the reference OAM modals and the reference OAM modal value are determined by the second communication device based on the PMIs and first channel information of the target antenna array units.

In an example, the transceiving module 1201 is further configured to determine at least one of a number of target OAM modals or a target OAM modal value selected and used by the first communication device, and send second modal indication information to the second communication device. The second modal indication information is configured to indicate at least one of the number of the target OAM modals or the target OAM modal value.

In an example, the transceiving module 1201 is further configured to determine at least one of the number of the target OAM modals or the target OAM modal value from at least one of the number of the reference OAM modals or the reference OAM modal value indicated by the second communication device.

In an example, the transceiving module 1201 is further configured to encode the reference signals according to the precoding matrices of the antenna array units, and send encoded reference signals to the second communication device for a channel estimation; receive second channel information corresponding to the antenna array units sent by the second communication device; and determine at least one of the number of the target OAM modals or the target OAM modal value according to the second channel information.

In an example, the transceiving module 1201 is further configured to select, before independently sending respective reference signals to the second communication device based on the target antenna array units among the antenna array units on the uniform circular array, K antenna array units from among N antenna array units on the uniform circular array as the target antenna array units, where N and K are positive integers greater than or equal to 2, and K≤N; and configure a corresponding reference signal for each target antenna array unit.

In an example, the processing module 1202 is further configured to determine the precoding matrix for each antenna array unit according to the relative position information and the configuration information of the uniform circular array.

In an example, the processing module 1202 is further configured to determine, after determining the precoding matrix for each antenna array unit, an OAM beamforming coefficient of each antenna array unit on the uniform circular array according to the target OAM modal value selected and used by the first communication device; and send, for each antenna array unit, information or data to the second communication device according to the OAM beamforming coefficient and the precoding matrix for the antenna array unit, or, receive for each antenna array unit, according to the OAM beamforming coefficient and the precoding matrix for the antenna array unit, information or data sent by the second communication device.

In a case where the communication apparatus 120 is the second communication device, the transceiving module 1201 is configured to receive reference signals sent independently by a first communication device through designated target antenna array units on a uniform circular array (UCA); and determine a PMI of each target antenna array unit based on the reference signals, and send the PMIs to the first communication device, where the PMIs are used to determine a precoding matrix for each antenna array unit on the uniform circular array.

In an example, the transceiving module 1201 is further configured to perform, for each target antenna array unit, a channel estimation based on the reference signals of the target antenna array units, obtain first channel information of the target antenna array units, and determine the PMIs of the target antenna array units according to the first channel information of the target antenna array units.

In an example, the transceiving module 1201 is further configured to determine an optimal codeword of the target antenna array unit from a preset codebook according to the first channel information of the target antenna array unit, and determine the PMI of the target antenna array unit according to the optimal codeword of the target antenna array unit.

In an example, the transceiving module 1201 is further configured to determine at least one of a number of reference OAM modals or a reference OAM modal value of the first communication device based on the PMIs and the first channel information of the target antenna array units, where the first channel information is determined according to the reference signals of the target antenna array units; and send first modal indication information to the first communication device, where the first modal indication information is configured to indicate at least one of the number of the reference OAM modals or the reference OAM modal value.

In an example, the transceiving module 1201 is further configured to receive second modal indication information sent by the first communication device, where the second modal indication information is configured to indicate at least one of a number of target OAM modals or a target OAM modal value selected and used by the first communication device.

In an example, at least one of the number of the target OAM modals or the target OAM modal value is at least one of a number of modals or a modal value determined from at least one of the number of the reference OAM modals or the reference OAM modal value sent by the second communication device.

In an example, the transceiving module 1201 is further configured to receive encoded reference signals sent by the first communication device through each antenna array unit, where the encoded reference signals are obtained by encoding the reference signals based on the precoding matrices for the antenna array units; and perform a channel estimation according to the encoded reference signals, so as to obtain second channel information of the antenna array units, and send the second channel information to the first communication device, where the second channel information is used to determine at least one of the number of the target OAM modals or the target OAM modal value.

In an example, the transceiving module 1201 is further configured to receive configuration information of the reference signal corresponding to each target antenna array unit sent by the first communication device; and receive the reference signal sent by each target antenna array unit based on the configuration information of the reference signals.

In an example, the transceiving module 1201 is further configured to determine an OAM beamforming coefficient of each antenna array unit on the uniform circular array of the second communication device according to the target OAM modal value selected and used by the first communication device; and send information or data to the first communication device according to the OAM beamforming coefficient and the precoding matrix for the antenna array unit, or, receive, according to the OAM beamforming coefficient and the precoding matrix for the antenna array unit, information or data sent by the first communication device.

In the present disclosure, respective precoding matrix for each unit on the UCA is obtained by interacting with the second communication device through part of the antenna array units, and information or data transmission is performed with the second communication device through the selected precoding matrix, resulting in a best transmission performance of the antenna array units. Further, the precoding matrices of the antenna array units may enable beamforming of the antenna array units to produce an effect of convergence toward a center in the air, thus facilitating the suppression of a divergence angle of an OAM beam, and solving, to a certain extent, a problem of being unable to transmit over a long distance due to a larger divergence angle of the OAM beam.

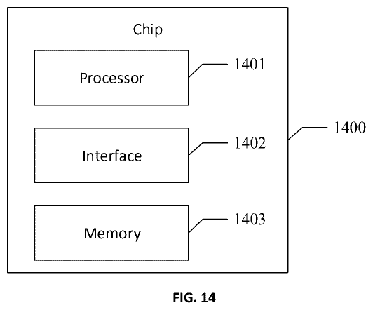

Please refer to FIG. 13. FIG. 13 is a schematic structural diagram of a communication apparatus 130 according to another embodiment of the present disclosure. The communication apparatus 130 may be a network device, may further be a terminal, may further be a chip, a chip system, or a processor, etc., that supports a network device to implement the methods, and may further be a chip, a chip system, or a processor, etc., that supports a terminal to implement the methods. The communication apparatus 130 may be configured to implement the methods described in the method embodiments, which may refer to the description in the method embodiments for details.

The communication apparatus 130 may include one or more processors 1301. The processor 1301 may be a general-purpose processor or a special-purpose processor, etc. The processor 1301 may be, for example, a baseband processor or a central processing unit. The baseband processor may be configured to process a communication protocol and communication data. The central processing unit may be configured to control a communication apparatus (e.g., a base station, a baseband chip, a terminal, a terminal chip, a DU or a CU, etc.), execute a computer program, and process data from the computer program.

In an example, the communication apparatus 130 may also include one or more memories 1302 on which a computer program 1304 may be stored. The processor 1301 executes the computer program 1304 to enable the communication apparatus 130 to perform the methods described in the method embodiments. In an example, data may also be stored in the memory 1302. The communication apparatus 130 and the memory 1302 may be arranged separately or may be integrated together.

In an example, the communication apparatus 130 may also include a transceiver 1305, and an antenna 1306. The transceiver 1305 may be referred to as a transceiving unit, a transceiver, or a transceiving circuit, etc., and is configured to implement a transceiving function. The transceiver 1305 may include a receiver 1308 and a transmitter 1309. The receiver 1308 may be referred to as a receiving machine or receiving circuit, etc., for implementing a receiving function. The transmitter 1309 may be referred to as a sending machine or sending circuit, etc., for implementing a sending function.

In an example, one or more interface circuits 1307 may also be included in the communication apparatus 130. The interface circuit 1307 is configured to receive code instructions and transmit the code instructions to the processor 1301. The processor 1301 runs the code instructions so as to enable the communication apparatus 130 to perform the method described in the method embodiment.

The communication apparatus 130 may be configured to perform steps as in the embodiments of the first communication device in the method embodiments.

The communication apparatus 130 may be configured to perform steps as in the embodiments of the second communication device in the method embodiments.

In an implementation, the processor 1301 may include a transceiver (not shown) configured to implement receiving and sending functions. For example, the transceiver may be a transceiving circuit, or an interface, or an interface circuit. The transceiving circuit, interface or interface circuit configured to implement the receiving and sending functions may be separate or integrated together. The transceiving circuit, interface or interface circuit may be used for reading and writing of a code/data, or the transceiving circuit, interface or interface circuit may be used for transmitting or transferring of a signal.

In an implementation, the processor 1301 may store a computer program 1303. The computer program 1303 runs on the processor 1301 to enable the communication apparatus 130 to perform the method described in the method embodiments. The computer program 1303 may be solidified in the processor 1301, in which case the processor 1301 may be implemented by hardware.

In an implementation, the communication apparatus 130 may include a circuit (not shown), and the circuit may implement the function of sending or receiving or communicating in the method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and the transceiver may also be fabricated using a variety of IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), and so on.

The communication apparatus 130 in the description of the embodiments may be a network device or a terminal (such as the first communication device in the method embodiment), but the scope of the communication apparatus 130 described in the present disclosure is not limited to this, and the structure of the communication apparatus 130 may not be limited by FIG. 13. The communication apparatus 130 may be a separate device or may be part of a larger device. For example, the communication apparatus 130 may be:
(1) a separate integrated circuit (IC), or chip, or, a chip system or subsystem;
(2) a set having one or more ICs, in an example, the set of ICs may also include a storage component for storing data and a computer program;
(3) an ASIC, such as a modem;
(4) a module that may be embedded within other devices;
(5) a receiver, a terminal, an intelligent terminal, a cellular phone, a wireless device, a handset, a mobile unit, an in-vehicle device, a network device, a cloud device, an artificial intelligence device, etc.; and
(6) other, etc.

For a case where the communication apparatus 130 may be a chip or a chip system, a schematic structural diagram of a chip shown in FIG. 14 may be referred to. The chip 140 shown in FIG. 14 includes a processor 1401 and an interface 1402. One or more processors 1401 may be arranged, and a plurality of interfaces 1402 may be arranged.

For a case where the chip 140 is configured to implement the functions of the first communication device in the embodiment of the present disclosure:
the interface 1402 is configured to independently send respective reference signals to a second communication device based on target antenna array units among antenna array units on a uniform circular array; and receive a precoding matrix index (PMI) of each target antenna array unit determined based on the reference signals and sent by the second communication device;
the processor 1401 is configured to determine a precoding matrix for each antenna array unit on the uniform circular array according to the PMIs of the target antenna array units.

In an example, the processor 1401 is further configured to determine relative position information of the second communication device according to the PMIs of the target antenna array units; and determine a precoding matrix for each antenna array unit on the uniform circular array according to the relative position information.

In an example, the processor 1401 is further configured to determine unit position information of the target antenna array units according to configuration information of the uniform circular array; determine direction angles between the target antenna array units and the second communication device according to the PMIs; and determine the relative position information of the second communication device according to the direction angles, the configuration information of the uniform circular array, and the unit position information.

In an example, the interface 1402 is further configured to receive first modal indication information sent by the second communication device. The first modal indication information is configured to indicate at least one of a number of reference OAM modals or a reference OAM modal value. The number of the reference OAM modals and the reference OAM modal value are determined by the second communication device based on the PMIs and first channel information of the target antenna array units.

In an example, the interface 1402 is further configured to determine at least one of a number of target OAM modals or a target OAM modal value selected and used by the first communication device; and send second modal indication information to the second communication device, where the second modal indication information is configured to indicate at least one of the number of the target OAM modals or the target OAM modal value.

In an example, the interface 1402 is further configured to determine at least one of the number of the target OAM modals or the target OAM modal value from at least one of the number of the reference OAM modals or the reference OAM modal value indicated by the second communication device.

In an example, the interface 1402 is further configured to encode the reference signals according to the precoding matrices of the antenna array units, and send encoded reference signals to the second communication device for a channel estimation; receive second channel information of the antenna array units sent by the second communication device; and determine at least one of the number of the target OAM modals or the target OAM modal value according to the second channel information.

In an example, the interface 1402 is further configured to select, before independently sending respective reference signals to the second communication device based on the target antenna array units among the antenna array units on the uniform circular array, K antenna array units from among N antenna array units on the uniform circular array as the target antenna array units, where N and K are positive integers greater than or equal to 2, and KEN; and configure a corresponding reference signal for each target antenna array unit.

In an example, the processor 1401 is further configured to determine the precoding matrix for each antenna array unit according to the relative position information and the configuration information of the uniform circular array.

In an example, the processor 1401 is further configured to determine, after determining the precoding matrix for each antenna array unit, an OAM beamforming coefficient of each antenna array unit on the uniform circular array according to the target OAM modal value selected and used by the first communication device; and send, for each antenna array unit, information or data to the second communication device according to the OAM beamforming coefficient and the precoding matrix for the antenna array unit, or, receive for each antenna array unit, according to the OAM beamforming coefficient and the precoding matrix for the antenna array unit, information or data sent by the second communication device.

For a case where the chip 140 is configured to implement the functions of the second communication device in the embodiment of the present disclosure:
the interface 1402 is configured to receive reference signals sent independently by a first communication device through designated target antenna array units on a uniform circular array; and determine a PMI of each target antenna array unit based on the reference signals, and send the PMIs to the first communication device, where the PMIs are used to determine a precoding matrix for each antenna array unit on the uniform circular array.

In an example, the interface 1402 is further configured to perform, for each target antenna array unit, a channel estimation based on the reference signal of the target antenna array unit, so as to obtain first channel information of the target antenna array unit; and determine the PMI of the target antenna array unit according to the first channel information of the target antenna array unit.

In an example, the interface 1402 is further configured to determine an optimal codeword of the target antenna array unit from a preset codebook according to the first channel information of the target antenna array unit; and determine the PMI of the target antenna array unit according to the optimal codeword of the target antenna array unit.

In an example, the interface 1402 is further configured to determine at least one of a number of reference OAM modals or a reference OAM modal value of the first communication device based on the PMIs and the first channel information of the target antenna array units, where the first channel information is determined according to the reference signals of the target antenna array units; and send first modal indication information to the first communication device, where the first modal indication information is configured to indicate at least one of the number of the reference OAM modals or the reference OAM modal value.

In an example, the interface 1402 is further configured to receive second modal indication information sent by the first communication device, where the second modal indication information is configured to indicate at least one of a number of target OAM modals or a target OAM modal value selected and used by the first communication device.

In an example, at least one of the number of the target OAM modals or the target OAM modal value is a number of modals or a modal value determined from at least one of the number of the reference OAM modals or the reference OAM modal value sent by the second communication device.

In an example, the interface 1402 is further configured to receive encoded reference signals sent by the first communication device through each antenna array unit, where the encoded reference signals are obtained by encoding the reference signals based on the precoding matrices for the antenna array units; and perform a channel estimation according to the encoded reference signals, obtain second channel information of the antenna array units, and send the second channel information to the first communication device, where the second channel information is used to determine at least one of the number of the target OAM modals or the target OAM modal value.

In an example, the interface 1402 is further configured to receive configuration information of the reference signals corresponding to each target antenna array unit sent by the first communication device; and receive the reference signals sent by each target antenna array unit based on the configuration information of the reference signals.

In an example, the interface 1402 is further configured to determine an OAM beamforming coefficient of each antenna array unit on the uniform circular array of the second communication device according to the target OAM modal value selected and used by the first communication device; and send information or data to the first communication device according to the OAM beamforming coefficient and the precoding matrices for the antenna array units, or, receive information or data sent by the first communication device according to the OAM beamforming coefficient and the precoding matrices for the antenna array units.

In an example, the chip 140 further includes a memory 1403. The memory 1403 is configured to store necessary computer programs and data.

In the present disclosure, respective precoding matrix for each unit on the UCA is obtained by interacting with the second communication device through part of the antenna array units, and information or data transmission is performed with the second communication device through the selected precoding matrix, resulting in a best transmission performance of the antenna array units. Further, the precoding matrices of the antenna array units may enable beamforming of the antenna array units to produce an effect of convergence toward a center in the air, thus facilitating the suppression of a divergence angle of an OAM beam, and solving, to a certain extent, a problem of being unable to transmit over a long distance due to a larger divergence angle of the OAM beam.

Those skilled in the art may further appreciate that various illustrative logical blocks and steps listed in the embodiments of the present disclosure may be implemented by electronic hardware, computer software, or a combination of the two. Whether such a function is implemented by hardware or software depends on a specific application and design requirements of an overall system. Those skilled in the art may, for each specific application, use various methods to implement the described function, but such implementation is not to be construed as being outside the scope of protection of the embodiments of the present disclosure.

An embodiment of the present disclosure further provides a system for determining a precoding matrix for OAM. The system (not shown) includes a communication apparatus as a first communication device and a communication apparatus as a second communication device in the embodiment of FIG. 12, or, the system includes a communication apparatus as a first communication device and a communication apparatus as a second communication device in the embodiment of FIG. 13.

The present disclosure further provides a non-transitory computer-readable storage medium on which instructions are stored. When executed by a computer, the instructions implement the function of any one of the method embodiments.

The present disclosure further provides a computer program product. When executed by a computer, the computer program product implements the function of any one of the method embodiments.

In the embodiments, the functions may be implemented in whole or in part by software, hardware, firmware, or any combination of them. When implemented by using software, the functions may be implemented in whole or in part in the form of the computer program product. The computer program product includes one or more computer programs. When the computer program is loaded and executed on a computer, the process or function described according to the embodiments of the present disclosure is generated in whole or in part. The computer may be a general-purpose computer, a special-purpose computer, a computer network, or other programmable apparatuses. The computer program may be stored in a non-transitory computer-readable storage medium or transmitted from one non-transitory computer-readable storage medium to another non-transitory computer-readable storage medium. For example, the computer program may be transmitted from one website, computer, server, or data center to another website, computer, server, or data center by wired (e.g., a coaxial cable, optical fiber, and digital subscriber line (DSL)) or wireless (e.g., infrared, wireless, microwave, etc.) means. The non-transitory computer-readable storage medium may be any available medium to which a computer can access or a data storage device such as a server, data center, etc., that contains one or more available medium integrations. The available medium may be a magnetic medium (e.g., a floppy disk, a hard disk, and a tape), an optical medium (e.g., a high-density digital video disc (DVD)), or a semiconductor medium (e.g., a solid state disk (SSD)), etc.

Those ordinarily skilled in the art may understand that first, second, and various other numerical numbers involved in the present disclosure are merely distinguished for descriptive convenience, are not used to limit the scope of the embodiments the present disclosure, and also indicate the order of precedence.

Wording “at least one” in the present disclosure may also be described as one or more, and a plurality may be two, three, four, or more, which is not limited by the present disclosure. In the embodiments of the present disclosure, for a technical feature, technical features in the technical feature are distinguished by “first”, “second”, “third”, “A”, “B”, “C”, “D”, etc. There is no order of precedence or magnitude among the technical features described in “first”, “second”, “third”, “A”, “B”, “C” and “D”.

Correspondences shown in tables in the present disclosure may be configured or may be predefined. Values of information in the tables are merely examples and may be configured to be other values, which is not limited by the present disclosure. When a correspondence between information and each parameter is configured, it is not necessarily required that all correspondences illustrated in each table must be configured. For example, the correspondence illustrated in certain rows of the tables in the present disclosure may also be unconfigured. As another example, appropriate transformation adjustments may be made based on the table, e.g., splitting, merging, etc. Names of parameters shown in headings in the tables may also be other names understandable by the communication apparatus, and values or representations of the parameters of which may also be other values or representations understandable by the communication apparatus. Each of the tables may also be implemented with other data structures. For example, an array, a queue, a container, a stack, a linear table, a pointer, a chained table, a tree, a graph, a structure, a class, a heap or a hash table, etc. may be used.

Wording “predefining” in the present disclosure may be understood as defining, defining in advance, storing, pre-storing, pre-negotiating, pre-configuring, curing, or pre-firing.

Those ordinarily skilled in the art may realize that units and algorithmic steps of the various examples described in conjunction with the embodiments disclosed can be implemented with electronic hardware, or a combination of computer software and electronic hardware. Whether these functions are implemented in a form of hardware or software depends on the specific application and design constraints of the technical solutions. Those skilled in the art may use different methods to implement the described functions for each specific application, but such implementation is not considered to be beyond the scope of the present disclosure.

It is clearly understood by those skilled in the art that, for the convenience and brevity of the description, the specific work processes of the systems, apparatuses, and units described can refer to the corresponding processes in the method embodiments, which will not be repeated.

The above is only the detailed description of the present disclosure, but the scope of protection of the present disclosure is not limited to this. Changes or replacements that can be easily figured out by any person skilled in the art within the technical scope disclosed in the present disclosure should be covered in the scope of protection of the present disclosure. Therefore, the scope of protection of the present disclosure shall be subject to the scope of protection of the claims.

1. A method for determining a precoding matrix for orbital angular momentum (OAM), performed by a first communication device, the method comprising:
independently sending respective reference signals to a second communication device based on target antenna array units among antenna array units on a uniform circular array;
receiving a precoding matrix index (PMI) of each target antenna array unit determined based on the reference signals and sent by the second communication device; and
determining a precoding matrix for each antenna array unit on the uniform circular array according to the PMIs of the target antenna array units.

2. The method according to claim 1, wherein determining the precoding matrix for each antenna array unit on the uniform circular array according to the PMIs of the target antenna array units comprises:
determining relative position information of the second communication device according to the PMIs of the target antenna array units; and
determining the precoding matrix for each antenna array unit on the uniform circular array according to the relative position information.

3. The method according to claim 2, wherein determining the relative position information of the second communication device according to the PMIs comprises:
determining unit position information of the target antenna array units according to configuration information of the uniform circular array;
determining direction angles between the target antenna array units and the second communication device according to the PMIs; and
determining the relative position information of the second communication device according to the direction angles, the configuration information of the uniform circular array, and the unit position information.

4. The method according to claim 1, further comprising at least one of the following:
receiving first modal indication information sent by the second communication device, wherein the first modal indication information is configured to indicate at least one of a number of reference OAM modals or a reference OAM modal value, and the number of the reference OAM modals and the reference OAM modal value are determined by the second communication device based on the PMIs and first channel information of the target antenna array units; or
before independently sending the respective reference signals to the second communication device based on the target antenna array units among the antenna array units on the uniform circular array, selecting K antenna array units from among N antenna array units on the uniform circular array as the target antenna array units and configuring a corresponding reference signal for each target antenna array unit, wherein N and K are positive integers greater than or equal to 2, and K≤N.

5. The method according to claim 1, further comprising:
determining at least one of a number of target OAM modals or a target OAM modal value selected and used by the first communication device; and
sending second modal indication information to the second communication device, wherein the second modal indication information is configured to indicate at least one of the number of the target OAM modals or the target OAM modal value.

6. The method according to claim 5, wherein determining at least one of the number of the target OAM modals or the target OAM modal value selected and used by the first communication device comprises at least one of the following:
determining at least one of the number of the target OAM modals or the target OAM modal value from at least one of a number of reference OAM modals or a reference OAM modal value indicated by the second communication device; or
encoding the reference signals according to the precoding matrices of the antenna array units, and sending encoded reference signals to the second communication device for a channel estimation, receiving second channel information of the antenna array units sent by the second communication device, and determining at least one of the number of the target OAM modals or the target OAM modal value according to the second channel information.

7-8. (canceled)

9. The method according to claim 2, wherein determining the precoding matrix for each antenna array unit on the uniform circular array according to the relative position information comprises:
determining the precoding matrix for each antenna array unit according to the relative position information and configuration information of the uniform circular array.

10. The method according to claim 9, wherein after determining the precoding matrix for each antenna array unit, further comprising:
determining an OAM beamforming coefficient of each antenna array unit on the uniform circular array according to a target OAM modal value selected and used by the first communication device;
sending, for each antenna array unit, information or data to the second communication device according to the OAM beamforming coefficient and the precoding matrix for the antenna array unit, or receiving for each antenna array unit, according to the OAM beamforming coefficient and the precoding matrix for the antenna array unit, information or data sent by the second communication device.

11. A method for determining a precoding matrix for orbital angular momentum (OAM), performed by a second communication device, the method comprising:
receiving reference signals sent independently by a first communication device through designated target antenna array units on a uniform circular array; and
determining a PMI of each target antenna array unit based on the reference signals, and sending the PMIs to the first communication device, wherein the PMIs are used to determine a precoding matrix for each antenna array unit on the uniform circular array.

12. The method according to claim 11, wherein determining the PMI of each target antenna array unit based on the reference signals comprises:
performing, for each target antenna array unit, a channel estimation based on the reference signal of the target antenna array unit to obtain first channel information of the target antenna array unit; and
determining the PMI of the target antenna array unit according to the first channel information of the target antenna array unit.

13. The method according to claim 12, wherein determining the PMI of the target antenna array unit according to the first channel information of the target antenna array unit comprises:
determining an optimal codeword of the target antenna array unit from a preset codebook according to the first channel information of the target antenna array unit; and
determining the PMI of the target antenna array unit according to the optimal codeword of the target antenna array unit.

14. The method according to claim 11, further comprising:
determining at least one of a number of reference OAM modals or a reference OAM modal value of the first communication device based on the PMI and first channel information of the target antenna array unit, wherein the first channel information is determined according to the reference signal of the target antenna array unit; and
sending first modal indication information to the first communication device, wherein the first modal indication information is configured to indicate at least one of the number of the reference OAM modals or the reference OAM modal value.

15. The method according to claim 11, further comprising:
receiving second modal indication information sent by the first communication device, wherein the second modal indication information is configured to indicate at least one of a number of target OAM modals or a target OAM modal value selected and used by the first communication device.

16. The method according to claim 15, wherein at least one of the number of the target OAM modals or the target OAM modal value is a number of modals or a modal value determined from at least one of a number of reference OAM modals or a reference OAM modal value sent by the second communication device.

17. The method according to claim 15, further comprising at least one of:
receiving an encoded reference signal sent by the first communication device through each antenna array unit, wherein the encoded reference signal is obtained by encoding the reference signal based on the precoding matrix for the antenna array unit; and obtaining second channel information of the antenna array unit by performing a channel estimation according to the encoded reference signal, and sending the second channel information to the first communication device, wherein the second channel information is used to determine at least one of the number of the target OAM modals or the target OAM modal value; or
determining an OAM beamforming coefficient of each antenna array unit on a uniform circular array of the second communication device according to the target OAM modal value selected and used by the first communication device; and sending information or data to the first communication device according to the OAM beamforming coefficient and the precoding matrix for the antenna array unit, or receiving, according to the OAM beamforming coefficient and the precoding matrix for the antenna array unit, information or data sent by the first communication device.

18. The method according to claim 11, wherein receiving the reference signals sent by the first communication device through each designated target antenna array unit on the uniform circular array comprises:
receiving configuration information of the reference signal corresponding to each target antenna array unit sent by the first communication device; and
receiving the reference signal sent by each target antenna array unit based on the configuration information of the reference signal.

19-21. (canceled)

22. A communication apparatus, comprising a processor and a memory, wherein a computer program is stored in the memory, and the processor executes the computer program stored in the memory so as to enable the communication apparatus to:
independently send respective reference signals to a second communication device based on target antenna array units among antenna array units on a uniform circular array;
receive a precoding matrix index (PMI) of each target antenna array unit determined based on the reference signals and sent by the second communication device; and
determine a precoding matrix for each antenna array unit on the uniform circular array according to the PMIs of the target antenna array units.

23. (canceled)

24. A non-transitory computer-readable storage medium, configured to store instructions, wherein the instructions, when executed by a processor, cause the processor to perform the method according to claim 1.

25. A communication apparatus, comprising a processor and a memory, wherein a computer program is stored in the memory, and the processor executes the computer program stored in the memory to cause the communication apparatus to perform the method according to claim 11.

26. A non-transitory computer-readable storage medium, configured to store instructions, wherein the instructions, when executed by a processor, cause the processor to perform the method according to claim 11.
